(19) United States
(12) Patent Application Publication
(10) Pub. No.: US 2004/0071866 A1
(43) Pub. Date: Apr. 15, 2004

(54) Method for manufacturing cathode electrode for secondary lithium battery using vanadium oxide

(76) Inventors: Yong Joon Park, Daejon-Shi (KR); Kwang Man Kim, Daejon-Shi (KR); Young Sik Hong, Daejon-Shi (KR); Xiang Lan Wu, Daejon-Shi (KR); Young Gi Lee, Daejon-Shi (KR); Kwang Sun Ryu, Daejon-Shi (KR); Soon Ho Chang, Daejon-Shi (KR)

Correspondence Address: JACOBSON HOLMAN PLLC, 400 SEVENTH STREET N.W., SUITE 600, WASHINGTON, DC, 20004, US

(21) Appl. No.: 10/321,816

(22) Filed: Dec. 18, 2002

(30) Foreign Application Priority Data
Oct. 9, 2002 (KR) 2002-61547

(51) Int. Cl. B05D 5/12; H01M 4/04; B05D 1/34

(52) U.S. Cl. 427/126.3; 427/201; 427/205

(57) ABSTRACT

The present invention relates to a method of manufacturing a cathode electrode for a secondary lithium battery using vanadium oxide. Vanadium oxide is dissolved in an aqueous solution containing H₂O₂ to form a gel. Thus, the gel can be applied to a metal support even when the binder is not used or the binder of a small amount is used. If vanadium oxide of an adequate amount is put into the aqueous solution containing. H₂O₂, a transparent aqueous solution is formed while oxygen is generated. The aqueous solution is then changed to a gel state of a viscosity as the time elapses. A small amount of a conductive material and a binder are added in the course that the gel is formed, and are then uniformly mixed with vanadium oxide being an active material, so that a slurry is formed. As the slurry has a high viscosity, it can be applied to the metal support even with a small amount of the binder. Further, as the conductive material, the binder, etc. are mixed in the course that the gel is formed, they are easily and uniformly mixed compared to a method by which the powder is mixed. Thus, the usage of the additive material can be reduced. Also, the present invention is environmentally friendly since solvent such as n-methyl pyrrolidone (NMP), acetone, etc. that is harmful to a human being is not used.

### BACKGROUND OF THE INVENTION

1. Field of the Invention

The invention relates generally to a method of manufacturing a cathode electrode for a secondary lithium battery, and more particularly to, a method of manufacturing a cathode electrode for a secondary lithium battery using vanadium oxide capable of preventing environmental pollution due to use of an organic solvent and reducing use of a binder.

2. Description of the Prior Art

Conventionally, a method of manufacturing a cathode electrode for a secondary lithium battery includes mixing a transfer metal oxide being a cathode active material in an organic solvent along with a binder, a conductive material, or the like to produce a slurry, applying the slurry to a current-collector for cathode such as an aluminum sheet or aluminum mesh and then drying it. At this time, the binder may include polyvinylidene chloride (PVdF), polyacrylonitride (PAN), poly vinyl chloride (PVC), methyl methacrylate (PMMA), poly methyl acrylate (PMA), and the like. As toxic substance such as n-methyl pyrrolidone (NMP) or acetone that is harmful to a human being is used as the organic solvent, it is harmful to a human being and environmental pollution is also caused.

### SUMMARY OF THE INVENTION

The present invention is contrived to solve the above problems and an object of the present invention is to provide a method of manufacturing a cathode electrode for a secondary lithium battery by which a slurry of a gel state is made, using an aqueous solution that is not harmful to a human being and a small amount of a binder.

In order to accomplish the above object, a method of manufacturing a cathode electrode according to the present invention, is characterized in that it comprises the steps of dissolving vanadium oxide in an aqueous solution containing H₂O₂ and during when vanadium oxide and the solution are reacting to each other, adding a conductive material to form a gel, removing moisture contained in the gel, applying the gel to a current-collector for cathode; and then drying the gel.

At this time, H₂O₂ that is contained in the aqueous solution is 5˜20 weight %. Also, the conductive material and the binder are together added.

Further, the conductive material is super P and the binder is carboxymethyl cellulose (CMC). The amount of the added conductive material is 3˜25 weight % when the total weight of vanadium oxide, the conductive material and the binder is 100 weight %, and the amount of the added binder is 0˜20 weight %. The moisture is removed by heating at a temperature of 60˜90° C.

The method further comprises the step of pressing and shaping the cathode electrode.

### BRIEF DESCRIPTION OF THE DRAWINGS

The aforementioned aspects and other features of the present invention will be explained in the following description, taken in conjunction with the accompanying drawings, wherein:

FIG. 1 shows a process flow for describing a method of manufacturing a cathode electrode for a secondary lithium battery using vanadium oxide according to a preferred embodiment of the present invention;

FIG. 2 is a graph illustrating an initial charge and discharge property of a half-cell using the cathode electrode manufactured by the method in FIG. 1; and

FIG. 3 is a graph illustrating a cycle property of the half-cell using the cathode electrode manufactured by the method in FIG. 1.

### DETAILED DESCRIPTION OF PREFERRED EMBODIMENTS

The present invention will be described in detail by way of a preferred embodiment with reference to accompanying drawings, in which like reference numerals are used to identify the same or similar parts.

If vanadium oxide reacts to an aqueous solution containing H₂O₂, a self sol-gel reaction is generated to form gel of a high viscosity. The present invention is characterized in that it uses this self sol-get reaction. A very severe self-exothermic reaction occurs when vanadium oxide is dissolved in H₂O₂. Thus, if the content of H₂O₂ in the aqueous solution is too high, the self-exothermic reaction is very abruptly generated. Due to this, not only vanadium oxide is changed to an amorphous state but also there is no time that vanadium oxide is mixed with an additive such as a conductive material, binder, or the like. On the contrary, if the content of H₂O₂ in the aqueous solution is too low, the rate of the self-exothermic reaction is too late and thus makes removing moisture difficult. In order to overcome the above problems, it is preferred that the content of H₂O₂ in the aqueous solution is in rage of 5˜20 weight %, more preferably about 10 weight %.

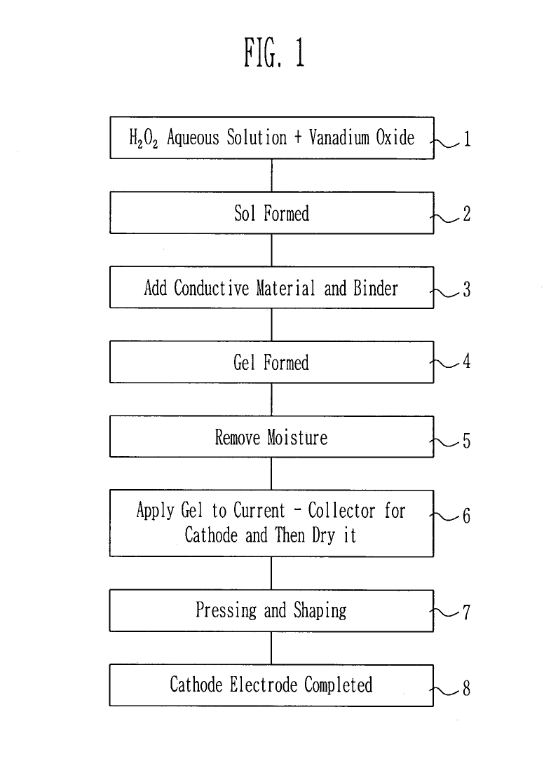

Referring now to FIG. 1, a method of manufacturing a cathode electrode for a secondary lithium battery using vanadium oxide according to a preferred embodiment of the present invention will be described.

Vanadium oxide (V₂O₅) as a cathode active material is added to an aqueous solution in which H₂O₂ of 5˜20 weight % is contained (Step 1). While oxygen (O₂) is generated due to a reaction of vanadium oxide and the aqueous solution based on Chemical Equation 1 below, a transparent aqueous solution, i.e., sol is formed in several minutes˜several hours (Step 2).

V₂O₅+nH₂O₂→V₂O₅.nH₂O+n/2O₂↑ [Equation 1]

In Equation 1, n is about 1.8. At this time, as not H₂O reacts to form new compound but H₂O enters the structure of vanadium oxide (V₂O₅), the mass ratio is varied depending on the concentration of H₂O₂, reaction temperature, and the like.

If generation of oxygen is stopped, a wool shape precipitate is generated in the aqueous solution. As the time elapses, the precipitate is expanded and is then changed to a gel of a reddish brown color. At this time, it is preferred that before the precipitate is completely changed to the gel, a conductive material is added and is then uniformly mixed through stirring, etc. (Step 3). Further, the conductive material may include a graphite powder having the conductivity such as super P. If the amount of the conductive material is too small, the conductivity of the cathode electrode is lowered. On the contrary, if the amount of the conductive material is too many, the discharge capacity of the cathode electrode is reduced. It is thus preferred that the amount of the conductive material is in range of about 3˜25 weight % (wt %) when the total weight of vanadium oxide, the conductive material and the binder is 100 weight % (wt %). At this time, though it is possible to apply a current-collector cathode by means of the viscosity of the gel even when the binder is not used, it is preferred that the amount of the binder of 0˜20 weight % is used in order to improve the binding force. If the content of the binder is too many, it adversely affects the ion and electron conductivity of the cathode electrode. At this time, the binder may include carboxymethyl cellulose (CMC), etc. which can be dissolved in the aqueous solution.

After the precipitate is completely changed to the gel (Step 4), the precipitate is heated in order to remove excess moisture. At this time, if the heating temperature is too high, it is difficult to obtain an adequate viscosity. Considering this, it is preferred that the temperature of heating the precipitated is in range of 60˜90° C. (Step 5). After the excess moisture is removed, a slurry of a gel state having a high viscosity is manufactured.

Next, the slurry is applied to the current-collector for cathode and is then dried at a temperature of over 100° C., thus forming the cathode electrode (Step 6). The current-collector for cathode may include aluminum sheet or aluminum mesh.

If the cathode electrode manufactured above is pressed and shaped (Step 7), the cathode electrode for the secondary lithium battery having a good property is completed (Step 8).

Then, the present invention will be described in detail by way of a preferred embodiment.

[Embodiment 1]

Vanadium oxide of 30 g is put in a distilled solution of 600 ml containing H₂O₂ of 10 weight %. After several minutes, vanadium oxide is all dissolved to form a solution of a sol state having an orange color. At this time, vanadium oxide continuously reacts to H₂O₂ for 1˜2 hours while oxygen is generated.

After generation of oxygen is stopped, a wool shape precipitate is formed and after several hours, the solution of sol starts to change to a gel of a reddish brown color. Next, before the solution of sol is completely changed to the gel, super P of 6.4 g as a conductive material is added and is then stirred for 24 hours. Therefore, the gel having a high viscosity is uniformly formed.

Excess moisture is removed by heating for 4 hours at a temperature of about 90° C. The gel is then covered by aluminum sheet. Next, the gel is dried for 10 hours at a temperature of 100° C. The dried cathode electrode is then pressed and shaped by means of a roll press machine, thus completing the cathode electrode for the secondary lithium battery.

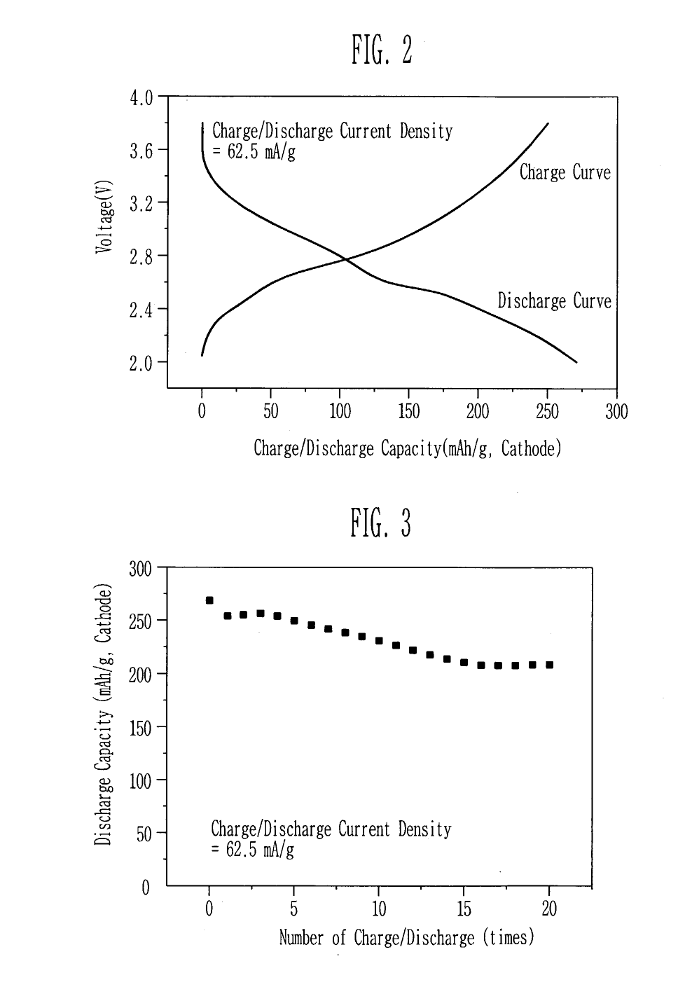

FIG. 2 is a graph illustrating an initial charge and discharge property of a half-cell using the cathode electrode manufactured by the method in FIG. 1. From the graph, it can seen that the initial charge capacity up to 2.0V reaches 280 mAh/g when the charge and discharge current density is 62.5 mA/g.

FIG. 3 is a graph illustrating a cycle property of the half-cell using the cathode electrode manufactured above FIG. 1. From the graph, it can be seen that the discharge capacity is relatively stable up to charge and discharge of 20 times.

[Embodiment 2]

Vanadium oxide of 30 g is put in a, distilled solution of 600 ml containing H₂O₂ of 10 weight %. After several minutes, vanadium oxide is all dissolved to form a solution of a sol state having an orange color. At this time, vanadium oxide continuously reacts to H₂O₂ for 1˜2 hours while oxygen is generated.

After generation of oxygen is stopped, a wool shape precipitate is formed and after several hours, the solution of sol starts to change to a gel of a reddish brown color. Next, before the solution of sol is completely changed to the gel, super P of 5 g as a conductive material and carboxymethyl cellulose (CMC) of 1 g as a binder are mixed and are then stirred for 24 hours. Therefore, the gel having a high viscosity is uniformly formed.

Excess moisture is removed by heating for 4 hours at a temperature of about 90° C. The gel is then covered by aluminum sheet. Next, the gel is dried for 10 hours at a temperature of 100° C. The dried cathode electrode is then pressed and shaped by means of a roll press machine, thus completing the cathode electrode for the secondary lithium battery.

It was found that the case employing the above embodiment has a higher binding force with the aluminum sheet than a case that the binder is not used.

As mentioned above, according to the present invention, a slurry of a gel state that can be applied and has a high viscosity is formed by means of a self sol-gel reaction of a solution containing H₂O₂ and vanadium oxide. Therefore, the present invention has outstand advantages that it can prevent environmental pollution and harmful damage to a human being since the solution not harmful to a human is employed. Further, a high viscosity can be maintained using a small amount of binder. As a conductive material and a binder are added in the course of the self sol-gel reaction, the conductive material and the binder are naturally uniformly mixed with the cathode active material. Therefore, the present invention can obtain the same effect even when the amount of the conductive material and the binder is small.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed is:

1. A method of manufacturing a cathode electrode, comprising the steps of:
dissolving vanadium oxide in an aqueous solution containing H₂O₂ and during when vanadium oxide and the solution are reacting to each other, adding a conductive material to form a gel;
removing moisture contained in the gel;
applying the gel to a current-collector for cathode; and
drying the gel.

2. The method as claimed in claim 1, wherein H₂O₂ contained in the aqueous solution is in range of 5˜20 weight %.

3. The method as claimed in claim 1, wherein the conductive material and the binder are together added.

4. The method as claimed in claim 3, wherein the conductive material is super P and the binder is carboxymethyl cellulose (CMC).

5. The method as claimed in claim 3, wherein the amount of the added conductive material is in range of 3˜25 weight % when the total weight of vanadium oxide, the conductive material and the binder is 100 weight %, and the addition amount of the binder is 0˜20 weight %.

6. The method as claimed in claim 1, wherein the moisture is removed by heating at a temperature of 60˜90° C.

7. The method as claimed in claim 1, wherein the current-collector for cathode is an aluminum sheet or an aluminum mesh.

8. The method as claimed in claim 1, further comprising the step of pressing and shaping the cathode electrode.
